(19) United States
(12) Patent Application Publication
(10) Pub. No.: US 2016/0309810 A1
(43) Pub. Date: Oct. 27, 2016

(54) WEARABLE DEVICE FOR CLEANING TOOLS WHEN TRIMMING PLANTS

(71) Applicant: Sarah Irene Jones, Humboldt County, CA (US)

(72) Inventor: Sarah Irene Jones, Humboldt County, CA (US)

(21) Appl. No.: 15/137,526

(22) Filed: Apr. 25, 2016

Related U.S. Application Data
(60) Provisional application No. 62/178,885, filed on Apr. 23, 2015.

(51) Int. Cl. A41D 13/08; B08B 1/00; A41D 31/00

(52) U.S. Cl. CPC A41D 13/081; A41D 31/0016; B08B 1/006; A41D 2400/62

(57) ABSTRACT

A flexible protective sleeve for cultivation of resinous plants, including a wristband and a tab projecting from the wristband. The sleeve has an inner layer and an outer layer, with an absorbent material layer between the outer layer and the inner layer, a moisture barrier between the absorbent material layer and the inner layer, a stabilizer for engaging a finger, the stabilizer fixed to the tab, and an abrasive area on the outer layer, for wiping residue from implements. A releasable contact fastener enables closing of the wristband over the wrist of the user when the sleeve is placed over the back of the hand and the wristband encircles the wrist of the user.

### CROSS-REFERENCE TO RELATED APPLICATION

This Application claims priority to pending Provisional U.S. Application Ser. No. 62/178,885, filed on Apr. 23, 2016, which application is incorporated herein by reference in its entirety.

### BACKGROUND OF INVENTION

Traditionally, tools used for manicuring resinous plants must be soaked in a solvent such as alcohol, oil, or a mix of the two in order to dissolve sticky residue left behind by the manicuring process. The tools must then be wiped down with an oily cloth to remove the residue. This is both time consuming and messy. In addition, in the experience of the Applicant, the motion of squeezing the oily rag around the tool, gripping and then wiping debris away aggravates Carpal Tunnel Syndrome. In order to manage physical health problems of Multiple Sclerosis and Carpal Tunnel Syndrome, the Applicant created a sleeve that provides the wearer a logical, effective, labor-saving means of cleaning tools.

### BRIEF SUMMARY OF INVENTION

My invention is a sleeve worn during the manicuring process of resinous plants, but its applications extend beyond the above described operation. In typical use, the sleeve fastens around the wrist of the non-dominant hand and covers the distal part of the forearm, wrist, and back of the hand extending over the fingers. The sleeve provides for the first time a means for easily cleaning tools, such as scissors, in the most sanitary and efficient way possible while manicuring resinous plants and flowers.

In accordance with the preferred embodiment of the invention, there is disclosed a top layer of material with an absorbent material layer at the distal portion which, when oil, alcohol, or other solvent is applied, acts a cleaning surface for tools (such as scissors). There is also disclosed an abrasive area located on the top layer below the area described as the absorbent material which acts as an area designated for scrubbing debris from tools. The addition of oil to the abrasive area may enhance the effectiveness. Said abrasive area could be located anywhere on the top layer so as to increase efficiency and ease of use, and may be made of a variety of materials such as nylon, polyester or other suitable material. There is also disclosed a stabilizer which anchors the top portion of sleeve to the hand. The stabilizer is shown as a loop, but could be a ring or any means of stabilizing the sleeve to the hand. There is also disclosed a fastener which secures sleeve around the wrist and forearm. The fastener shown is a hook and loop fastener, but could be snaps, buttons, elastic, or any suitable fastener that secures the sleeve in place.

The wearer rubs dirty tools on the absorbent material or abrasive scrubbing area containing oil or solvent which is to be applied by wearer. This cleans the tools quickly, safely and efficiently. The wearer does not have to put down their work in order to clean their tools with an oily rag. This saves the wearer time, is more sanitary, and gives the potential to increase productivity and accuracy, as well as minimize the risk of injury.

The sleeve is made preferably of materials that are machine washable making it easy and convenient to clean. The sleeve can be used to clean any small tools used for manicuring resinous plants, or any other useful purpose the wearer may have for it. My invention provides for the first time the means to clean tools used in the manicuring process of resinous plants in the most productive, “hands-free” way possible.

### BRIEF DESCRIPTION OF THE DRAWINGS

A presently preferred embodiment will hereinafter be described in conjunction with the appended drawings, wherein like designations denote like elements, and wherein:

FIG. 1 is a plan view of a protective sleeve as if spread out on a flat surface, according to at least one aspect of the invention;

FIG. 2 shows the reverse of the protective sleeve of FIG. 1;

FIG. 3 is an exaggerated view of FIG. 1, wherein layers of the protective sleeve are depicted as spread apart to reveal internal detail;

FIG. 4 is an exaggerated view of FIG. 1, showing the order of layers in the constituent material of the protective sleeve;

FIG. 5 is an environmental plan view of the protective sleeve of FIG. 1 installed on the hand of a wearer; and

FIG. 6 shows the opposite view of FIG. 5.

### DETAILED DESCRIPTION

Detailed descriptions of the preferred embodiment are provided herein. However, it should be understood that the present invention may be embodied in various forms. Therefore, specific details disclosed within are not to be interpreted as limiting, but rather as a basis for any claims, and as a basis for teaching one skilled in the art to fabricate the invention in any appropriate structure or manner.

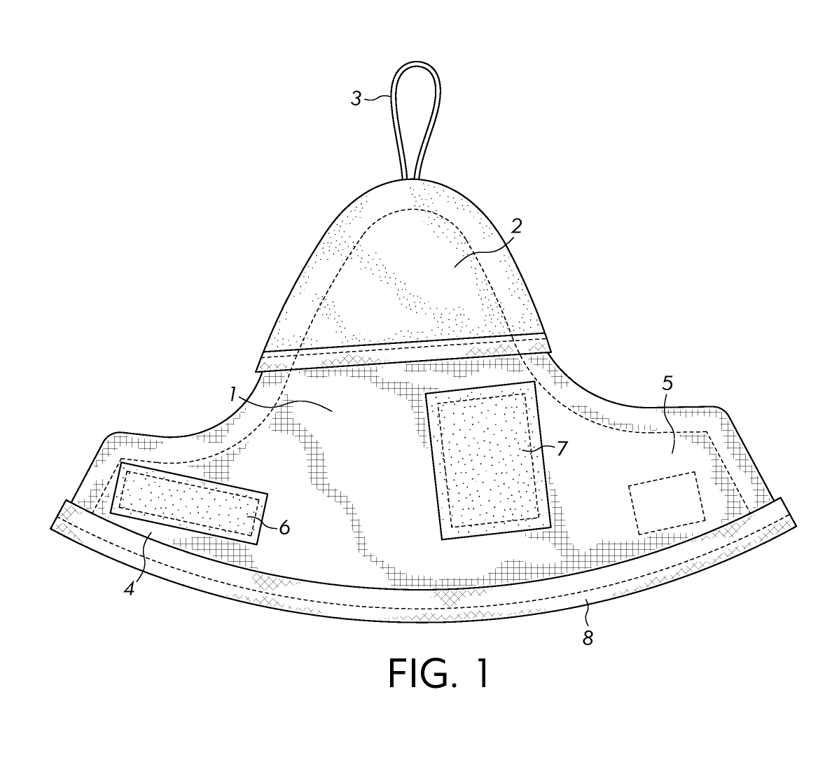

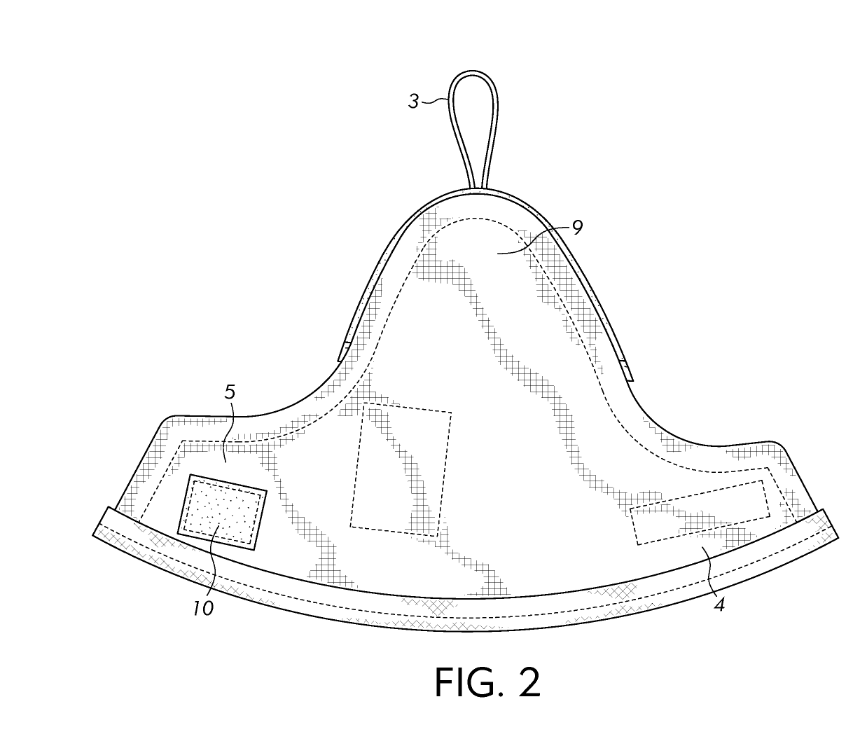

In FIG. 1 is the sleeve as viewed from the top/outside, and shows the top/outside material 1 and the absorbent material 2 positioned at the distal part of the sleeve. These materials are stitched together at the edges. The stabilizer 3 is stitched toward at the top center of sleeve. Stabilizer 3 is worn on one or more fingers of the hand so as to secure the sleeve to the back of hand and fingers of the user. The abrasive area 7 is stitched on top/outside material 1 below the absorbent material 2. The fastener 6 is stitched to loop side of wristband 4. The fastener shown in the drawings is a hook and loop fastener (such as Velcro® ™) for purpose of example, but could be snaps, buttons hooks, elastic or any other fastener suitable to secure sleeve to wrist. The fasteners must be attached in such a way so that when the loop side of wristband 4 is wrapped around the wrist, the hook side of wristband 5 will securely fasten around the wrist and forearm. For purposes of the example provided in the drawings, the loop fastener 6 and the hook fastener 10 in FIG. 2 are stitched in a position that does not irritate the wrist. The bottom edge 8 is stitched in a way that secures all layers of material together which provides stability to the sleeve. The drawings in FIGS. 1-2 show the bottom edge 8 as finished with a decorative seam binding or hem which is stitched over bottom edge 8 to further secure material layers of sleeve together and provide further stability as well as visual appeal. 3. The protective sleeve comprises a periphery, and may comprise a hem extending along the periphery.

FIG. 2 shows the bottom/inside of sleeve that rests on the back of the hand. The inside material 9 is stitched to the front materials in FIG. 1 1, 2 with stitching around the edge of the sleeve. The fastener 10 in this drawing is the hook side of a hook and loop fastener, but could be snaps hooks, buttons, or any suitable fastener that will secure sleeve to wrist and forearm. Where hook and loop fastening material is used, the first portion 6 comprises hook and loop fastener of one polarity, and the second portion 10 comprises hook and loop fastener of an opposed polarity.

The fastener 10 is stitched to wristband 5 in such a way so that when wristband 4 is wrapped around the wrist wristband 5 will fasten securely around and forearm. The stabilizer 3 is shown, as well as the bottom edge 8.

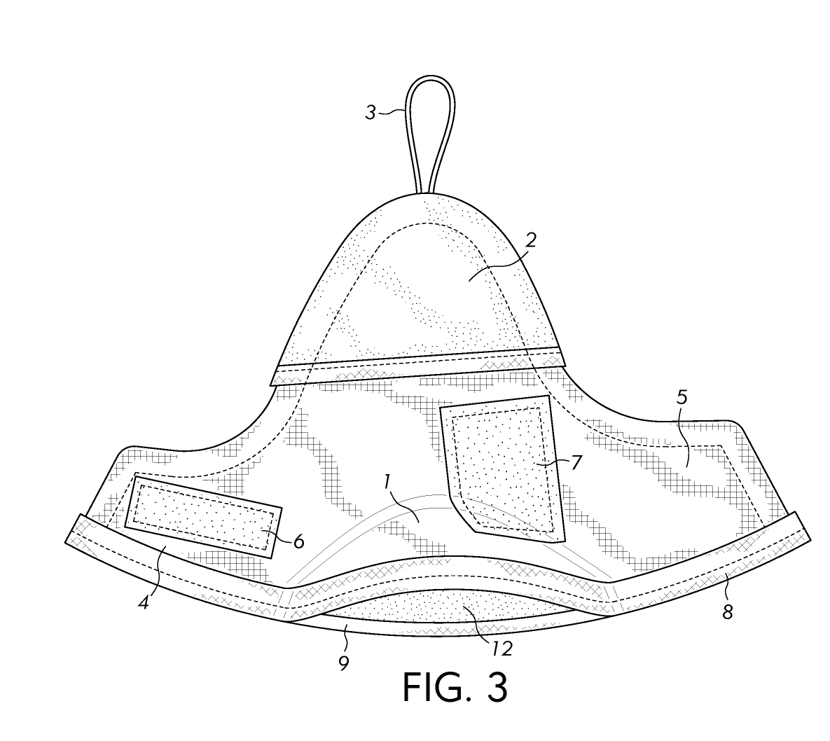

FIG. 3 shows a cut-away view of sleeve at bottom edge showing inner moisture barrier 12 which is stitched in between top material 1 and bottom material 9. This moisture barrier provides protection from substances (such as plant exudates) applied to absorbent material 2 and abrasive area 7.

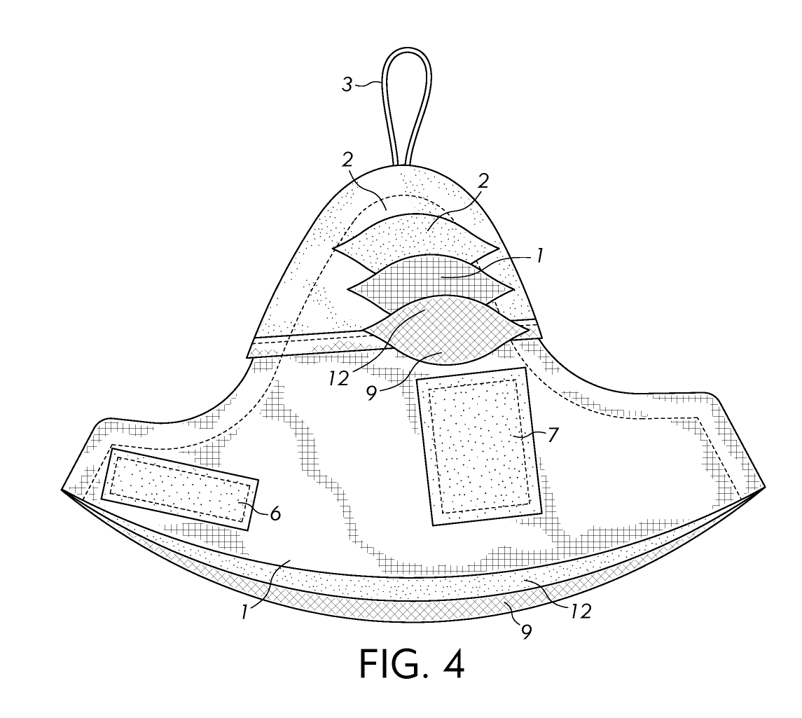

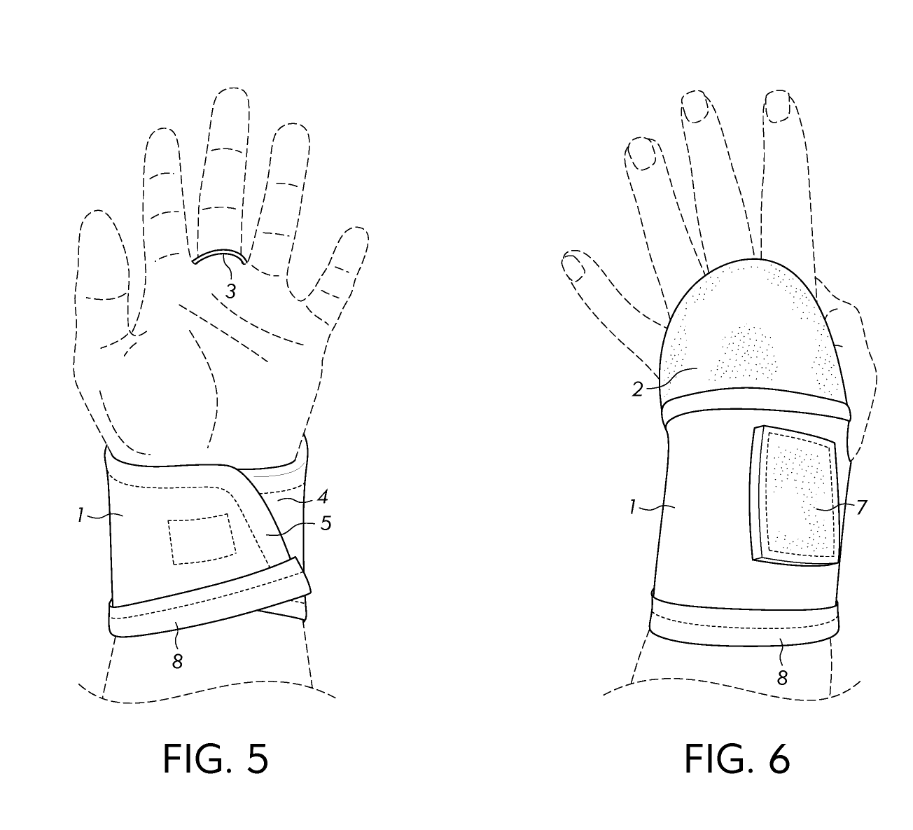

FIG. 4 shows a more detailed cut-away view of all material layers in every area of sleeve. In this example the absorbent material is an extra layer at the distal portion of top material layer 1. However, for purposes of simplicity the entire top material layer 1 may be made of absorbent material 2 eliminating the need for four layers of material. Absorbent material 2 is a material which absorbs and retains resinous exudates from plants, whether water based or oil based.

The inner layer and outer layer (outside material 1) are fabricated from a woven or non-woven fabric.

In summary, a protective sleeve for cultivation of resinous plants may comprise a flexible panel including wristband 4 and a tab projecting from wristband 4. The tab comprises an attachment region joined to wristband 4 and an opposed rounded end. The flexible panel may further comprise an inner layer 9 and an outer layer 1, an absorbent material layer 2 between outer layer 1 and inner layer 9, moisture barrier 12 between absorbent material layer 2 and inner layer 9, a stabilizer 3 fixed to the tab, and abrasive area 7 on outer layer 1. The protective sleeve may further comprise a fastener comprising a first portion 5 on wristband 4 and a second portion 6 on wristband 4 in a location overlying and contacting first portion 5 when wristband 4 is folded over onto itself.

Wristband 4 is curved when viewed in plan, and comprises an inside edge and an opposed outside edge. The tab projects from the inside edge.

What is claimed is:

1. A protective sleeve for cultivation of resinous plants, the protective sleeve comprising a flexible panel including a wristband and a tab projecting from the wristband, the flexible panel further comprising:
an inner layer and an outer layer;
an absorbent material layer between the outer layer and the inner layer;
a moisture barrier between the absorbent material layer and the inner layer;
a stabilizer fixed to the tab;
an abrasive area on the outer layer; and
a fastener comprising a first portion on the wristband and a second portion on the wristband in a location overlying and contacting the first portion when the strap is folded over onto itself.

2. The protective sleeve of claim 1, wherein the wristband is curved when viewed in plan, and comprises an inside edge and an opposed outside edge, and the tab projects from the inside edge.

3. The protective sleeve of claim 2, wherein the protective sleeve comprises a periphery, and a hem extending along the periphery.

4. The protective sleeve of claim 1, wherein the tab comprises an attachment region joined to the wristband and an opposed rounded end.

5. The protective sleeve of claim 1, wherein the inner layer and the outer layer are fabricated from a woven or non-woven fabric.

6. The protective sleeve of claim 1, wherein the first portion comprises hook and loop fastener of one polarity, and the second portion comprises hook and loop fastener of an opposed polarity.
